(19) United States
(12) Patent Application Publication
(10) Pub. No.: US 2021/0287161 A1
(43) Pub. Date: Sep. 16, 2021

(54) SYSTEMS FOR ACCESSING, PROCESSING, AND OUTPUTTING INVENTORY, SERVICE, AND SUPPLY CHAIN PARAMETER DATA

(71) Applicant: 3M INNOVATIVE PROPERTIES COMPANY, St. Paul, MN (US)

(72) Inventors: Viruru Phaniraj, Woodbury, MN (US); Karl W. Bloedorn, Menlo Park, CA (US); Samuel J. Anderson, Roseville, MN (US); Michael J. Lovell, Stillwater, MN (US); Peter H. Hockey, Menlo Park, CA (US); Jennifer L. Austin, Lino Lakes, MN (US); Jeffrey L. Ranch, Woodbury, MN (US); Andrew J. Pung, Stillwater, MN (US); David C. Borchard, Inver Grove Heights, MN (US); Donald S.D. Hart, II, Minneapolis, MN (US); Jim D. Jacob, Cottage Grove, MN (US); Kirk R. Soule, Stanton, MN (US); Matthew J. Siemer, Cottage Grove, MN (US); Scott R. Jilek, Minnetonka, MN (US)

(21) Appl. No.: 17/249,706

(22) Filed: Mar. 10, 2021

Related U.S. Application Data
(63) Continuation-in-part of application No. 16/818,424, filed on Mar. 13, 2020.

(51) Int. Cl. G06Q 10/08; G06F 3/0484

(52) U.S. Cl. CPC G06Q 10/087; G06F 3/04842

(57) ABSTRACT

A computing system may receive an indication of a selected facility item that represents a particular supply chain item processed at a particular facility, render, for display, a first view of a user interface pertaining to the selected facility item, that includes an item flow map that shows a flow of the particular supply chain item represented by the selected facility item between at least two facilities, receive a selection of a user interface element shown within the first view of the user interface; and in response to receipt of the selection of the user interface element, render, for display on the screen, a second view of the user interface that shows additional information pertaining to the selected facility item or the particular facility represented by the selected facility item, where the additional information is not shown in the first view of the user interface.

This application is a continuation-in-part of U.S. patent application Ser. No. 16/818,424, filed on 13 Mar. 2020, the entire content of which is incorporated herein by reference.

### BACKGROUND

Inventory management is a critical task for many businesses and other organizations that depend on the flow of goods and services between different locations. Considering the global scale of the modern economy, supply chains often extend across vast geographic areas, and can implicate flows of large numbers of goods and services. Individual facilities such as plants or warehouses that process (e.g., manufacture, store, or distribute) goods and services in a supply chain often maintain detailed records concerning the facility's local processing of such goods and/or services.

### SUMMARY

While individual facilities often maintain records concerning that particular facility's local processing of goods and/or services, business leaders and other stakeholders may have need to review supply chain data across facilities in the organization. Business leaders and other stakeholders may further have the need to review supply chain data aggregated from multiple facilities. Due to factors such as the volume of information available, differences in supply chain management systems employed at different facilities, and non-standardized metrics employed at one or more facilities, it can be difficult for users to quickly and efficiently access relevant data to gather desired supply chain insights. For example, some supply chain management software require users to click through many screens to access relevant data about items processed at various facilities in the supply chain.

This disclosure describes systems, methods, devices, and other techniques for efficiently accessing and outputting inventory and supply chain data. While various formats of human-understandable output are consistent with the systems of this disclosure, this disclosure primarily describes visual output formats as non-limiting examples. An inventory and supply chain management system of this disclosure can be configured to render a user interface (UI) via a native application, widget, third party application, web application, web browser, etc. running on a client device. The inventory and supply chain management systems of this disclosure generate the UIs in an interactive way, in that the systems enable users to select a “facility item” (e.g., an object representing a particular item) via the UI. As used herein, the objects may represent a raw material, a component of a manufactured good, a semi-finished good, a finished good, or any other item or service that is processed at a particular facility in a supply chain.

Upon receiving data indicating a user's selection of the facility item, the supply chain management system of this disclosure may invoke an updated version of the UI pertaining to the selected facility item, such as by outputting, for display, a new view of the same, different, or partially overlapping data pertaining to the selected facility item in comparison to the previous view. For example, the supply chain management systems may initially launch the UI can initially in a first view that presents a first mode of information about the facility item, and includes controls or control elements. The supply chain management systems of this disclosure may use the controls presented in the first view of the UI to enable a user of the client device to quickly transition to other views of the UI that present alternate modes of information about the facility item. Different modes of information may entail different amounts of information, different types of information, different visual presentations of information, etc. while adhering to data precision standards, such as by remaining factually consistent at a given time across the different modes.

As one example, the first view may be a geographical-based view having an item flow map that shows flows of the item from a first facility to one or more upstream or downstream facilities in the supply chain. In this example, other views may show more detailed or data—rich information about the facility item, such as, but not limited to, trends in the facility's processing of the item over time. Moreover, users can quickly transition to UI views that present data pertaining to upstream or downstream facilities, including the upstream/downstream facility's processing of the same item represented by the user's initial item selection as represented by activating a control element of a previously presented UI view.

As another example, the supply chain management systems of this disclosure may render, via the client device, a UI view that visually indicates values of one or more metrics such as inventory levels, trends, and/or on-time and in-full order fulfilment (OTIF) for a set of facilities in a supply chain. These and other techniques of this disclosure can provide an improved experience that allow users to quickly access and visualize relevant information about a supply chain. For instance, the supply chain management systems of this disclosure transition UI views in response to receiving user input data in a way that enables the user to filter potentially vast amounts of information, thereby targeting or isolating specific information of interest. The supply chain management systems of this disclosure also enable users to interact via the UIs by providing selection input with respect to readily accessible controls presented via one or more of the UI views. For example, the supply chain management systems of this disclosure may, in response to receiving a user input selecting one a control element presented via one view of the UI, cause the display device of the client device to switch between UI views that correspond to different modes of information about a selected item. Likewise, the supply chain management systems of this disclosure may quickly navigate to information about related facilities in the supply chain in response to receiving certain user input (or sequences thereof) while reducing the computing resources, bandwidth, and time that would otherwise be expended if separately traverse a multitude of screens outside the context of a currently accessed facility.

Implementations of the subject matter described herein include computer-implemented methods, and the methods can be carried out by a system of one or more computers in one or more locations (e.g., via local computing, distributed computing, software as a service (SaaS), etc.). In one example consistent with aspects of this disclosure, a computing system can receive an indication of a selected facility item. The selected facility item can represent a particular supply chain item that is processed at a particular facility of a set of facilities in an organization. The system can render, for display on a screen of the computing system, a first view of a user interface pertaining to the selected facility item. The first view of the user interface can include an item flow map that shows a flow of the particular supply chain item represented by the selected facility item between at least two facilities including the particular facility represented by the selected facility item. The computing system can receive a selection of a first user interface element within the first view of the user interface, and in response, render a second view of the user interface that shows additional information pertaining to the selected facility item or the particular facility represented by the selected facility item, the additional information representing data that is not shown in the first view.

These and other implementations can further include none, one, or more of the following features.

Receiving the indication of the selected facility item can include receiving an indication of (i) an item identifier that uniquely represents the particular supply chain item and (ii) a facility identifier that uniquely represents the particular facility.

The first user interface element can be a tab that is included in both the first and second views of the user interface.

In some examples, to the second view of the user interface does no include the item flow map. The second view of the user interface may include at least one other user interface element that shows the additional information pertaining to the selected facility item or the particular facility represented by the selected facility item.

In some examples, the additional information pertaining to the selected facility item comprises values of one or more metrics related to processing of the particular supply chain item at the particular facility. The one or more metrics related to the processing of the particular supply chain item at the particular facility can be comprise one or more of a monetary value of inventory of the particular supply chain item at the particular facility, a quantity of the particular supply chain item at the particular facility, a target level of the inventory of the particular supply chain item at the particular facility, a level of backorders of the particular supply chain item at the particular facility, and a percentage of on-time and in-full (OTIF) deliveries of the particular supply chain item made from the particular facility.

In some examples, the second view of the user interface includes a plot showing values of one or more metrics related to the processing of the particular supply chain item at the particular facility over a predetermined interval of time. In some examples, the predetermined interval of time is adjustable based on user input received via input hardware of the computing system.

The computing system can receive, while the second view of the user interface is rendered for display, user input data indicating a selection of the first user interface element or a second user interface element, and in response to receiving the user input data indicating the selection of the first user interface element or the second user interface element, rendering, by the computing system for display on the screen, the first view of the user interface that includes the item flow map.

The computing system can receive, via input hardware of the computing device, while the first view of the user interface is rendered for display or while the second view of the user interface is rendered for display, user input data indicating a selection of a second user interface element, and in response to receiving the user input data indicating the selection, render, for display on the screen, a third view of the user interface pertaining to a processing of the particular supply chain item represented by the selected facility item at a second facility that represents one of (i) an upstream facility that supplies the particular supply chain item to the particular facility, or (ii) a downstream facility that receives a supply of the particular supply chain item from the particular facility.

In some examples, the computing device may collect data identifying the particular facility represented by the selected facility item, identify a second facility upstream of the particular facility that supplies the particular supply chain item to the particular facility, and identify one or more third facilities other than the particular facility that are located downstream of the second facility such that the second facility supplies the one or more third facilities with the particular supply chain item. To render the first view of the user interface, the computing device may render visual markers on the item flow map corresponding to the particular facility, the second facility, and the one or more third facilities.

The particular facility represented by the selected facility item may be shown in focus in the first view of the user interface. The computing device may receive, while the particular facility is shown as being in focus, a first user input indicating a selection of a second user interface element. In response to receiving the first user input indicating the selection of the second user interface element, the computing device may: show the particular facility as not being in focus; and show a second facility as being in focus, wherein the second facility is either an upstream facility or a downstream facility of the particular facility with respect to the particular supply chain item. In these examples, the computing system may receive a second user input indicating a selection of the first user interface element or a third user interface element while the second facility is shown as being in focus, and in response to receiving the second user input indicating the selection of the first user interface element or the third user interface element, render, for display by the screen, a view of the user interface that pertains to the second facility.

The user interface can be rendered in and by a web browser application installed on the computing system. The item flow map can include a background map of a geographic region and a set of visual markers overlaid on the background map. The set of visual markers may include a first visual marker corresponding to the particular facility represented by the selected facility item, one or more second visual markers corresponding to one or more other facilities in the organization that are different from the particular facility and process the particular supply chain item represented by the selected facility item, and one or more third visual markers depicting a flow of the selected facility item between the at least two facilities.

Additional aspects of the techniques described in this specification include a computing system configured to carry out the actions and methods disclosed herein. The computing system can include one or more processors (e.g., processing devices, processing circuitry, etc.) and one or more computer-readable media. The computer-readable media (e.g., non-transitory media and/or computer-readable storage device(s)) can have instructions stored thereon that, when executed by the one or more processors, cause the one or more processors to perform any of the actions and methods disclosed in this specification. In yet a further aspect, the one or more computer-readable media can be made available apart from the system, and encoded with instructions that, when executed by one or more processors, cause the one or more processors to perform any of the actions and methods disclosed in this specification.

The details of particular implementations of the subject matter described in this specification are set forth in the accompanying drawings and the description below. Other features, aspects, and advantages of the subject matter will be apparent from the description, the drawings, and the claims.

### BRIEF DESCRIPTION OF DRAWINGS

FIG. 1 is a block diagram illustrating an example computing system for processing and presenting supply chain data from a group of facilities, in accordance with one or more aspects of this disclosure.

FIG. 2 is a flowchart illustrating an example process for efficiently transitioning between views of a user interface using an item flow map, in accordance with one or more aspects of this disclosure.

FIG. 3A-3D are conceptual diagrams depicting screenshots of example interactions via a user interface including an item flow map, in accordance with one or more aspects of this disclosure.

FIG. 4A-4E are conceptual diagrams depicting screenshots of an example user interface showing representations of facilities in a supply chain, in accordance with one or more aspects of this disclosure.

FIG. 5 is a flowchart of an example process for rendering and interacting with a map displaying representations of facilities in a supply chain, in accordance with one or more aspects of this disclosure.

FIG. 6 is a schematic diagram of a computing system having components operable to implement aspects of the computer-implemented methods and other techniques described herein, in accordance with one or more aspects of this disclosure.

### DETAILED DESCRIPTION

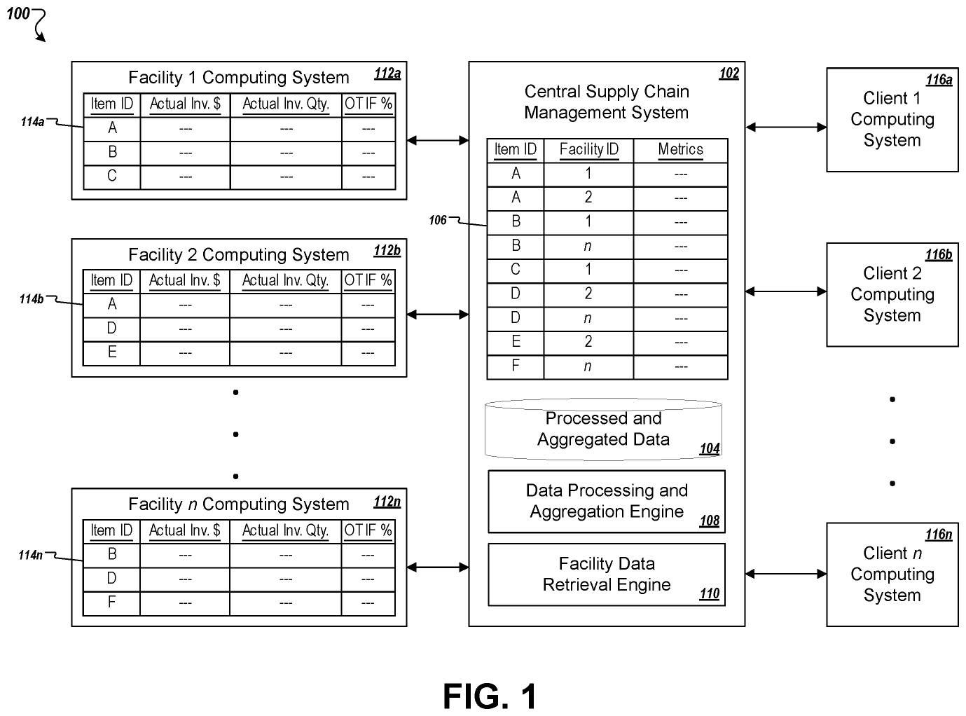

FIG. 1 is a block diagram illustrating an example computing system 100 configured to process and present supply chain data in accordance with one or more aspects of this disclosure. The computing system 100 includes a central supply chain management system 102, one or more facility computing systems 112a-n, and one or more client computing systems 116a-n. As shown, client computing systems 116a-n are operable to connect and communicate over one or more networks (e.g., a local area network, wide area network, a mobile network, the Internet, or any other communicative network, data network, packet-switched network, etc. configured to provide the data communication functionalities described herein) with central system 102. Likewise, central system 102 is operable to connect and communicate over one or more networks (e.g., a local area network, wide area network, a mobile network, the Internet, or any other communicative network, data network, packet-switched network, etc. configured to provide the data communication functionalities described herein) with facility systems 112a-n. In some implementations, computing system 100 employs a client-server model (e.g., based on a hub-and-spoke network architecture) in which central system 102 is configured as a server that responds to requests from client computing systems 116a-n and facility systems 112a-n, although other forms of communication (e.g., push systems) are also consistent with aspects of this disclosure.

Computing system 100, in some use case scenarios, is maintained and/or operated by or on behalf of a business, enterprise, or other organization that produces, distributes, stores, or otherwise processes items in a supply chain. In the course of maintaining the supply chain, the organization may operate or partner with various facilities at disparate geographic locations. For example, the facilities may include manufacturing plants that process raw materials and produce finished or semi-finished goods, distribution centers and warehouses that store goods ready for distribution in a local geographic region, retailers that shelve finished goods for sale to the end customer, supplier facilities that furnish to the organization items used in a manufacturing or production process, or any combination of these.

Often, each individual facility in the supply chain maintains electronic records related to operation of that particular facility. The records may be maintained in enterprise resource planning (ERP) software or ERP systems, relational databases, spreadsheets, customized facility-specific software, supply chain management systems, or any other type of software platform, data storage repository, or combinations thereof. A warehouse, for instance, may maintain records describing inventory levels (e.g., quantities) of each type of item (e.g., each stock-keeping unit (“SKU”)) currently stored in the warehouse, records describing expected deliveries of various items to and from the warehouse over upcoming periods of time, and records describing historical inventory levels in the warehouse. A manufacturing plant may maintain records of raw material levels used in manufacturing a finished good, planned production levels, actual production levels, and inventory levels of semi-finished or finished goods. Other facilities may maintain similar records corresponding to the respective function of the facility.

Facility systems 112a-n are the computing systems that manage and maintain records pertaining to operations of the facility. Each facility system 112 represents a respective computing system that manages and maintains operational records for a different facility of the supply chain. For instance, facility system 112a may correspond to a supplier's facility, facility system 112b may correspond to a manufacturing facility, and facility system 112n may correspond to a distribution center. While only three facility systems are expressly shown in FIG. 1, it should be understood that computing system 100 may encompass many facility systems, e.g., tens, hundreds, or potentially even thousands of facilities for larger organizations. Each respective facility system 112 may be implemented on one or more computers at one or more locations. In some cases, a given facility system 112 may be physically located on the premises of the facility itself, although other arrangements are possible. In some implementations, a same set of one or more computers may manage and maintain records on behalf of multiple facilities, in which case the facility system for each facility may correspond to the logical portion of the set of computers that manages and maintains records on behalf of the individual facility.

Central system 102 includes one or more computers in one or more locations and is configured to process data received from each of the facility systems 112a-n. One functionality of central system 102 is to make data from across the facilities in a supply chain readily available to client computing systems 116a-n in a shared, standardized, or universal format. For example, central system 102 may include a facility data retrieval engine 110 that manages retrieval of data from facility systems 112a-n. Retrieval engine 110 enables central system 102 to access current data from each facility on a continuous, periodic, or otherwise regular basis. In some implementations, retrieval engine 110 maintains continuous connections with each facility system 112a-n. In these implementations, central system 102 may receive information about updates to local facility data happening at each of the facility systems 112a-n via automatic push communications transmitted over the continuous connection in real-time. In some implementations, retrieval engine 110 may initiate connections to the facility systems 112a-n according to a predetermined schedule (e.g., every hour, every 12 hours, every 24 hours, every 48 hours, etc.) and obtain the latest facility data from the facility via request during these scheduled sessions. Additionally or alternatively, facility systems 112a-n may automatically push updated facility data to the central system 102 on a scheduled or regular basis, or otherwise upon the occurrence of certain triggering events.

Central system 102 further includes data processing and aggregation engine 108. Data processing and aggregation engine 108 processes initial data received from individual ones of facility systems 112a-n to generate actionable data that is suitable for provision to and consumption by client computing systems 116a-n. In some implementations, generation of actionable data includes re-formatting data received from the individual facility systems 112a-n into a common, standard, or universal format. In many cases, different facilities may use different software platforms and/or different record keeping conventions and practices. Data processing and aggregation engine 108 is configured to resolve differences in data formats stemming from these variations in local recordkeeping practices.

Data processing and aggregation engine 108 can also perform data aggregation and consolidation operations to determine values of supply chain metrics that are not directly computed by the individual ones of facility systems 112a-n. For example, facility systems 112a-n may each maintain individual data sets 114a-n that indicate, for each item (e.g., as tracked by SKU) processed at the corresponding facility, actual inventory levels of the item (in U.S. dollars or other currency unit and/or item quantity), trends pertaining to the item, and/or percentage of on-time and in-full (OTIF) deliveries (or order fulfilment). Some items may be processed only at a particular facility to the exclusion of other facilities (e.g., items C, E, and F), while other items are processed at multiple facilities (e.g., items A, B, and D).

As shown in table 106, data processing and aggregation data processing and aggregation engine 108 may consolidate information received from facilities 112a-n into a merged data set that includes records for each “facility item” in the supply chain. As used herein, a facility item is an object that represents a particular facility's processing of a particular item in a supply chain. The same item processed by two different facilities (e.g., item A with respect to both facility IDs 1 and 2 in table 106) can be represented as two different facility items, for example.

Central system 102 manages records for each facility item in the supply chain. For instance, as further shown in table 106, central system 102 maintains metadata for each facility item. Examples of such metadata include, but are not limited to, values of one or more supply chain metrics, such as actual inventory levels, trends, OTIF, backorder amounts, target inventory levels, sales amounts, delivery projections, demand forecasts, etc. Data processing and aggregation engine 108 may also be configured to automatically pre-aggregate metadata (e.g., values of supply chain metrics) for groups of two or more facility items. For example, data processing and aggregation engine 108 may aggregate the metadata associated with all or a subset of items processed by an individual facility to derive facility-wide metrics.

Additionally, data processing and aggregation engine 108 may aggregate the metadata associated with all of or a subset of facilities that process a particular item or a particular group of items to derive overall item metrics for individual items or groups of items across facilities. In some implementations, data processing and aggregation engine 108 is programmed to automatically compute aggregated metrics on a regular or scheduled basis for a preselected set of groups of facility items by client computing systems 116a-n (e.g., a set of “most popular” facility item groups that are frequently accessed by client computing systems 116a-n).

Additionally, individual ones of client computing systems 116a-n and users of these individual ones of client computing systems 116a-n may request aggregation of metadata for additional groups of facility items on either a one-time or recurring (e.g., regular/periodic/scheduled) basis. Actionable data that is made accessible to client computing systems 116a-n, including re-formatted, merged, and aggregated data, can be stored in volatile and/or non-volatile memory in one or more data structures (e.g., databases) of a repository, such as a repository represented by processed and aggregated data 104 in FIG. 1. Central system 102 may expose an application programming interface (API) to client computing systems 116a-n, allowing client computing systems 116a-n to access data from the repository represented by processed and aggregated data 104 on an as-needed basis.

Client computing systems 116a-n allow end users to access and review supply chain data made available from central system 102. In some implementations, client computing systems 116a-n may access supply chain data from sources other than or in addition to central system 102. For instance, some client computing systems 116a-n may obtain data directly from individual facility systems 112a-n. Any of client computing systems 116a-n can be a desktop computer, notebook computer, tablet computer, smartphone, or any other suitably equipped user-facing device. One or more of client computing systems 116a-n can include processing and storage capabilities, a display, and input devices that allow the device to receive user inputs (e.g., keyboards, mouse, camera, microphone, touch sensors).

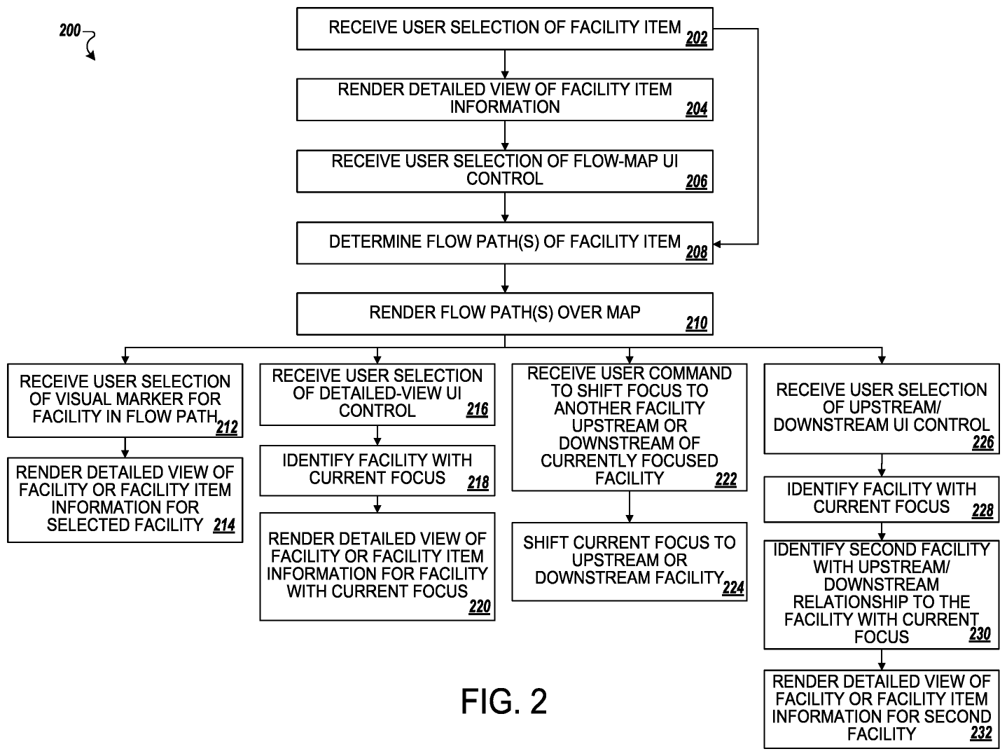

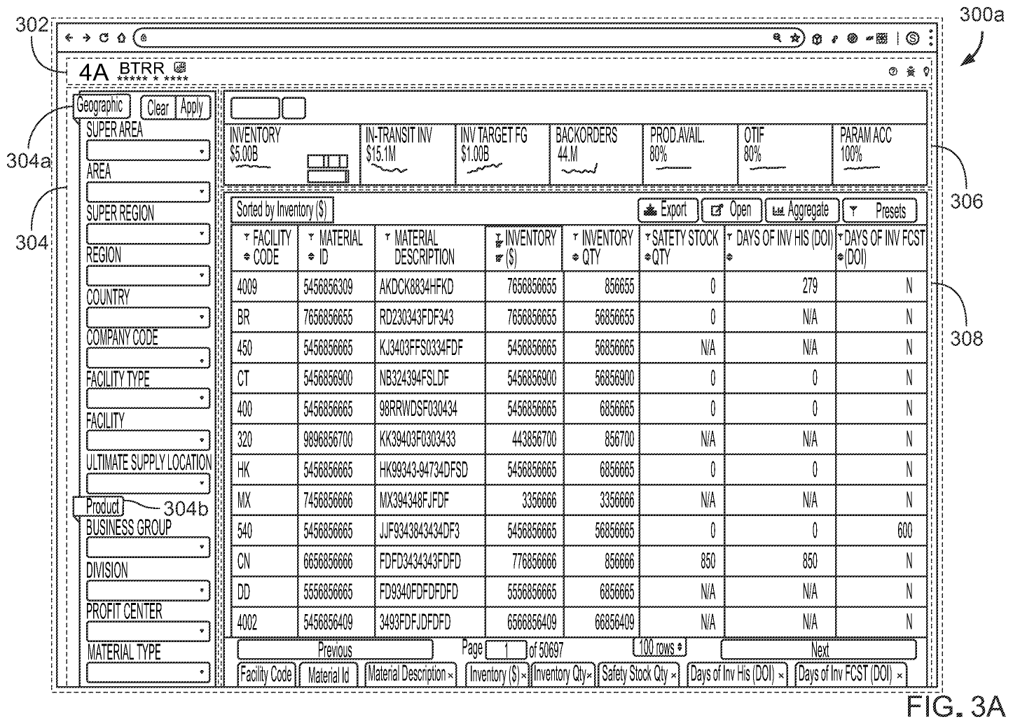

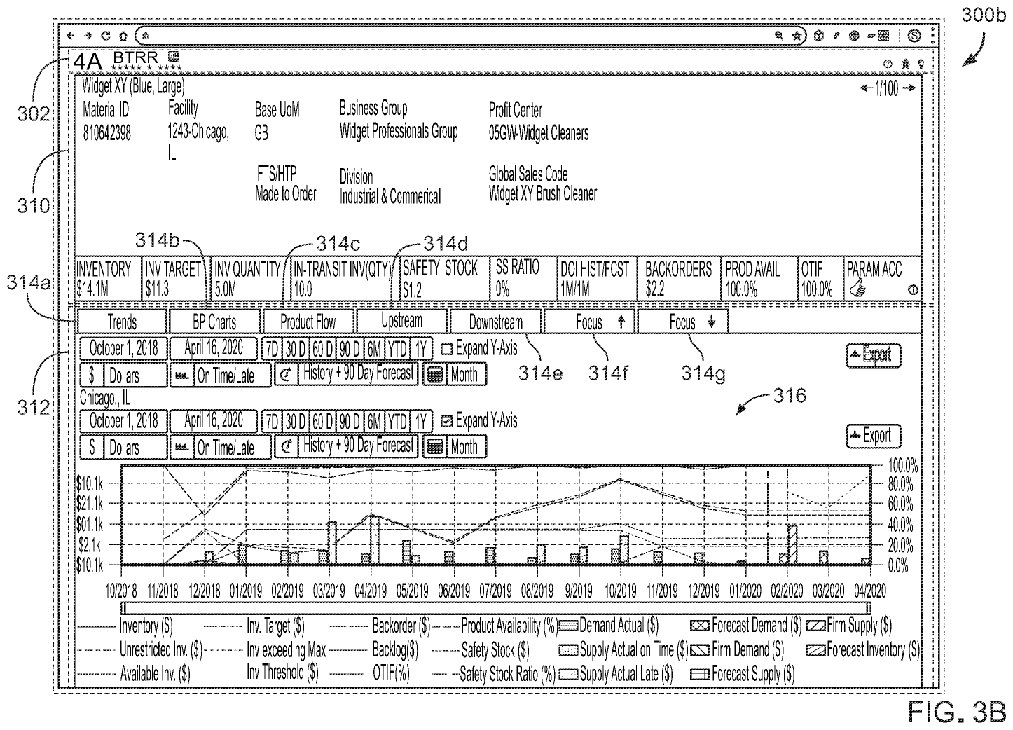

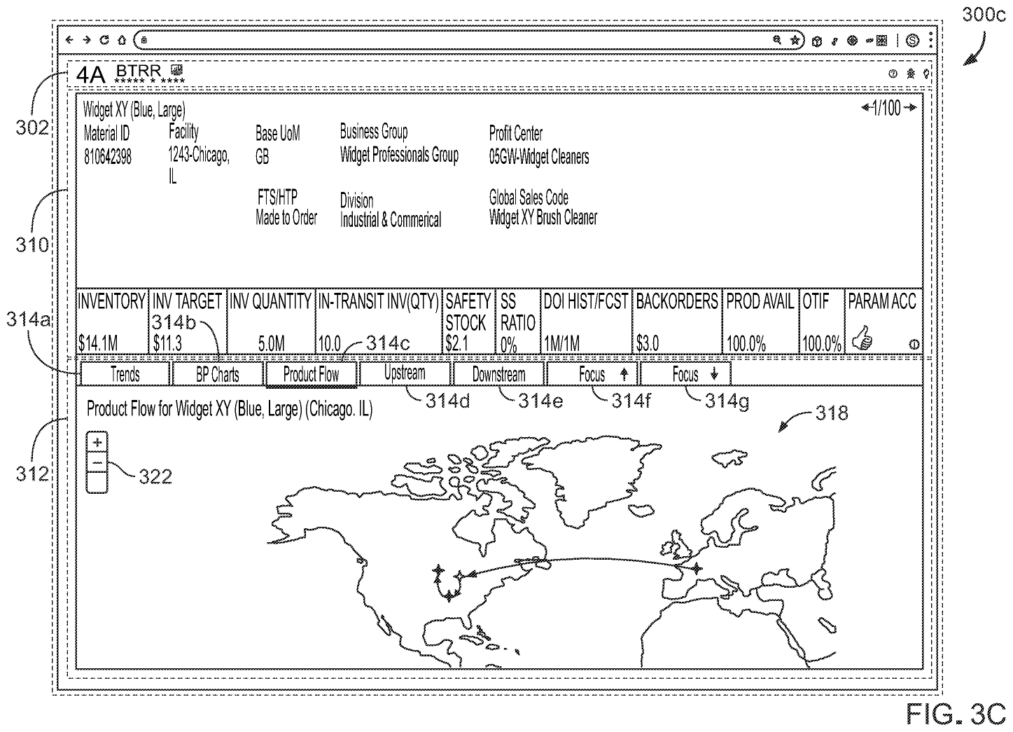

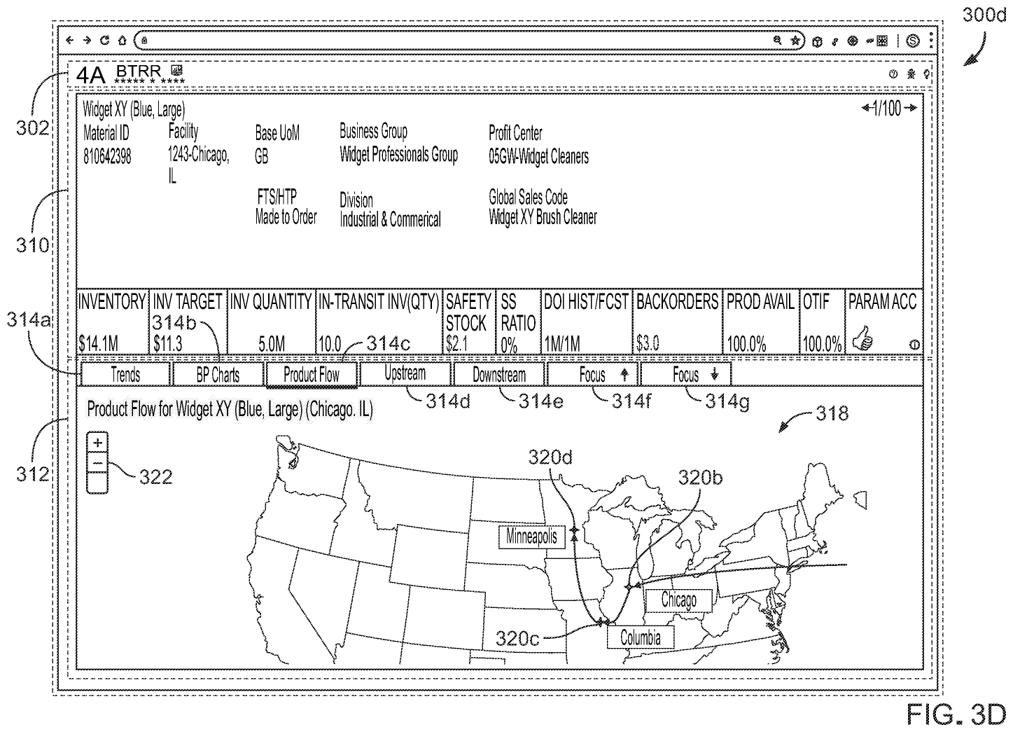

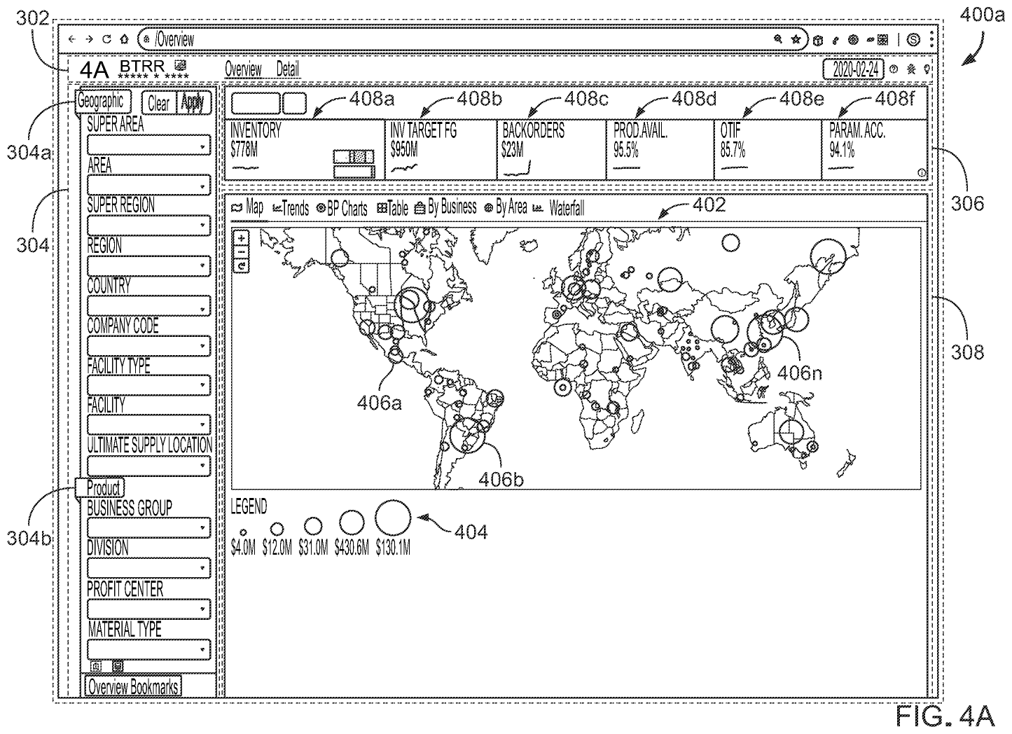

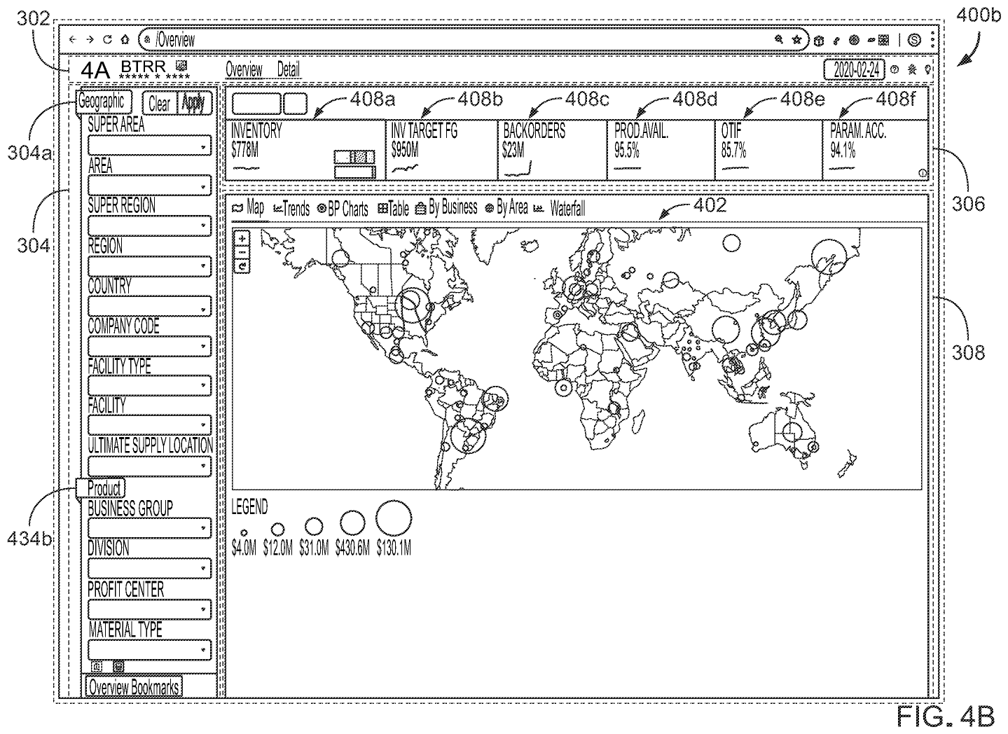

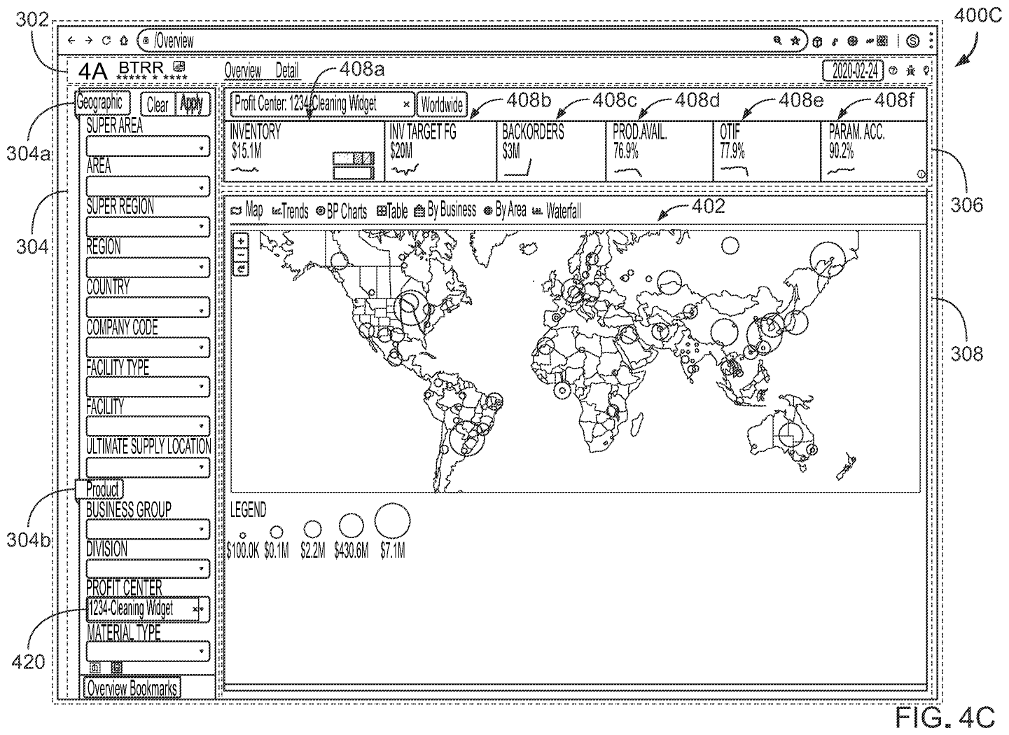

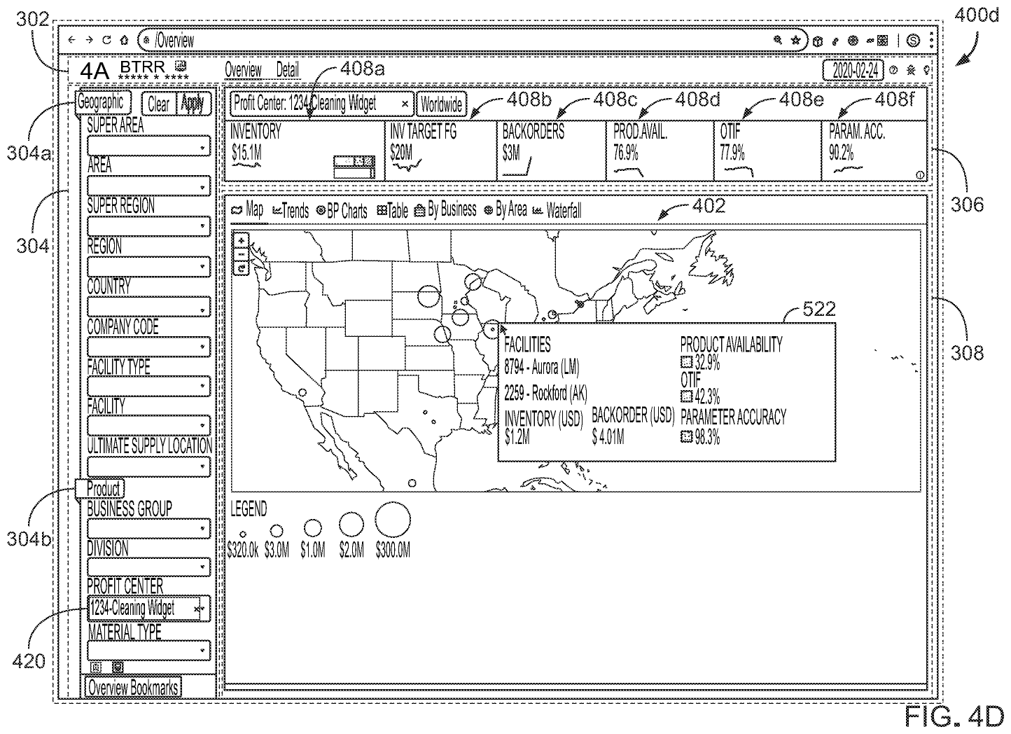

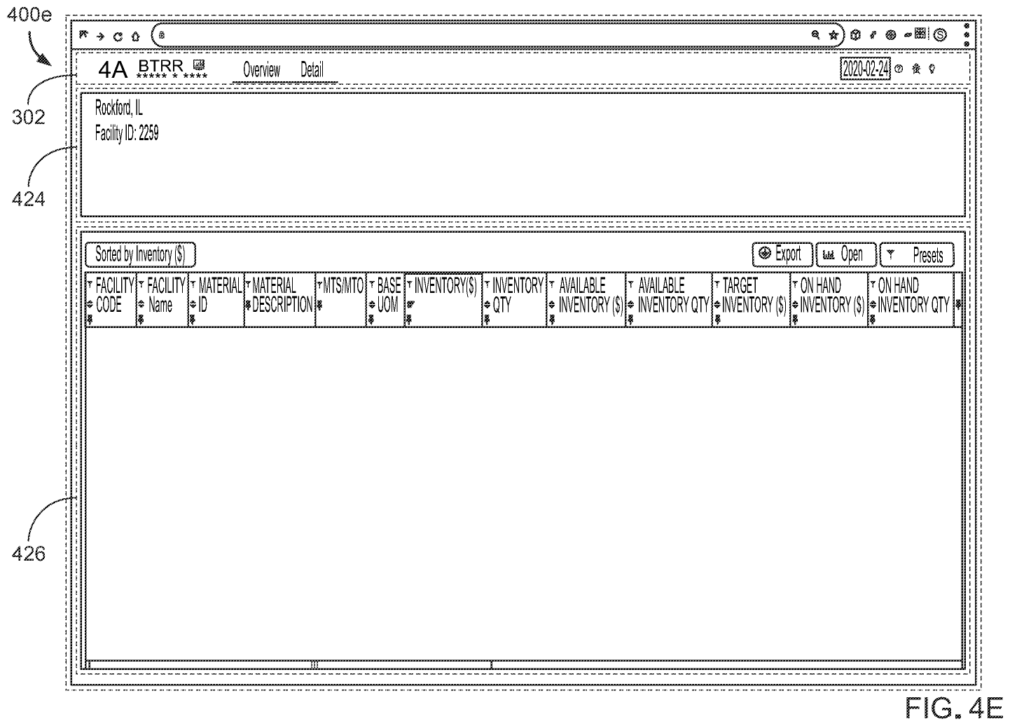

Client computing systems 116a-n can further implement software or firmware that renders UIs for presentation (e.g., for display or visual output) to a user of the device. Non-limiting examples of UIs that client computing systems 116a-n may render in accordance with aspects of this disclosure are shown in FIGS. 3A-4E and described below with reference to FIGS. 2-5. In some implementations, client computing systems 116a-n may execute native applications for rendering the UIs, such as applications that are dedicated to supply chain management. In other implementations, the client computing systems 116a-n may access web applications that render the UIs through a web browser.

By way of the functionalities and device configurations described above with respect to FIG. 1, computing system 100 provides several technical improvements in the technical field of distributed computing systems, particularly distributed computing systems configured to support the often data-rich area of supply chain management. By aggregating and pre-processing data collected from numerous facilities (some of which may collect, store, and communicate data in disjointed formats) into formats that are commonly used by client computing systems 116a-n, central system 102 implements the techniques of this disclosure to improve data precision in terms of the supply chain data processed by and output by client computing systems 116a-n. Moreover, by consolidating the format conversion and data aggregation functionalities at the server level, which often has the benefit of more powerful computing and storage capabilities, central system 102 mitigates or potentially eliminates the duplication of computing resource consumption that would occur across client computing systems 116a-n if client computing systems 116a-n performed the formatting, aggregation, and other data pre-processing steps to place processed and aggregated data 104 in user-consumable condition.

Additionally, by consolidating processed and aggregated data 104 at the server level in a format that is distributable across client computing systems 116a-n, central system 102 reduces the bandwidth consumption that would otherwise be incurred if client computing systems 116a-n were required to search for the pertinent one of facility systems 112a-n that held the particular facility item information requested by a user before successfully obtaining the requested facility item information. With the scalability of distributed supply chains, the computing resource and bandwidth saving advantages of the techniques of this disclosure are exponential when implemented across the numerous devices encompassed by computing system 100.

FIG. 2 is a flowchart illustrating an example process 200 for efficiently accessing and visualizing supply chain data at a client device, in accordance with one or more aspects of this disclosure. Process 200 can be performed by the front-end of a supply chain management system, e.g., by computing system 100 of FIG. 1. In some implementations, process 200 is performed by a client device of an end user, e.g., any of client computing systems 116a-n of FIG. 1. In general, process 200 provides key data on historical, current, and/or projected aspects of a supply chain quickly, enabling users to gain key insights. In contrast to traditional approaches that could several user inputs (e.g., a series of clicks, taps, or other input media) and invoke redundant resource usage to navigate through many screens to access relevant and related data sets, aspects of computing system 100 implement process 200 to invoke and use a UI that provides access to such data more quickly based on certain user inputs and with reduced processing overhead. These and other advantages of the techniques illustrated in FIG. 2 will be appreciated from the description below.

Process 200 can begin with one or more components of computing system 100 receiving a user's selection of a facility item (202). The facility item can be selected in a UI presented via output hardware of a client device, e.g., by display hardware of any of client computing systems 116a-n. The UI may be rendered and output by a native application installed on the respective client computing system 116, via a web application accessed through a web browser on the respective client computing system 116, or by other suitable programmable circuitry or hardware executing software on the respective client computing system 116. In some implementations, one or more of client computing systems 116a-n may output a filtered list of facility items represented in Table 106, such as a list that is filtered based on stored user preferences, or based on other criteria. As some non-limiting examples, any of client computing systems 116a-n may present the filtered list for display upon the host application being accessed or invoked, in response to a receiving a search query submitted by the user for facility items that match specified search criteria, in response to a user's selection of a filter to filter a universe of facility items to generate the filtered set/subset of facility items in the filtered list, etc. In these implementations, may receive, via its respective input hardware, a user selection of a particular facility item from the filtered list.

For example, FIG. 3A is a conceptual diagram depicting a screenshot of a view 300A of a UI that any of client computing systems 116a-n may output, for display, to an end user. Aspects of computing system 100 may operate the UI shown in FIG. 3A to effectate facility item selections in response to receiving various types of user input via input hardware of the respective client computing system 116. The view 300A of the UI can be rendered by an application running at the respective client computing system 116, or by an application provided by central system 102 to client computing systems 116a-n as part of a centrally hosted cloud computing solution (e.g., SaaS). The view 300A may include various UI elements that present information to the user, provide a control that makes the UI interactive, such that user input associated with an area at or near the control triggers an action in the UI, or both.

View 300A includes several display regions 302, 304, 306, and 308 within a single window of the UI. Display region 302 can include header information that sets context for the UI, such as a logo for the organization that maintains the software platform and/or manages the supply chain. Display region 302 can also provide UI elements (e.g., tabs) that are universally accessible from a range of views of the UI, regardless of the operational or computational stage of the running application at which the user is currently using the application. These global controls can include a help tab, a settings tab, an account tab, or others, which can be selected to access, respectively, help, settings, account information, or other information that may be desired by a user.

Display region 304 provides controls that allow a user to search and/or filter facility items registered in the supply chain management system. In some implementations, display region 304 includes a first set of UI elements 304a that provide search and filter capabilities. For instance, aspects of computing system 100 may present the results of searches and/or filtering of facility items via display hardware of a client computing system 116 based on one or more criteria (e.g., geographic criteria and/or other criteria) provided in a user input. As shown, the geographic criteria can include a super area, a (minor) area, a super region, a (minor) region, a country, a company code, a facility type, a facility name or identifier, an ultimate supply location, or a combination of all or some of these. The geographic search/filtering criteria may allow the user to restrict identification of facility items to those items that are processed at facilities that match the specified geographic criteria.

In the example of view 300A, display region 304 also includes a second set of UI elements 304b. Client computing systems 116a-n and/or central system 102 may process user input received at the display locations of or associated with the second set of UI elements 304b to implement search and/or filter operations with respect to facility items based on product attributes, such as the business group of the target product(s), business division of the target product(s), profit center of the target product(s), material type of the target product(s), or others. For example, a large industrial conglomerate may manufacture and distribute products ranging from chemicals to appliances to medical devices. In these and other such scenarios, the product searching and/or filtering capabilities provided by computing system 100 reduce computing resources expended for data retrieval and reduce bandwidth consumption by reducing the amount of data that is processed to fulfill a data request received via one or more of client computing systems 116 a-n.

By enabling restricting or constraining the identification of facility items in response to user input received at client computing systems 116a-n to those facility items that are within specific sectors, business groups, or profit centers, etc., aspects of computing system 100 improve data precision in terms of providing output data that more precisely targets the user input-provided request, and also conserves bandwidth and computing resource usage that would otherwise be expended to retrieve and transmit more voluminous data. In some implementations, client computing systems 116 a-n and/or central system 102 may process typed user input (e.g., typed into a text box, etc.) provided at the locations of or associated with UI elements in display region 304 to determine the search and/or filtering criteria, and may activate/issue the search and/or filter command in response to a selection input provided at a button, tab, or other control.

In one example, an application running on an of client computing systems 116a-n may submit the search/filtering command to a server, e.g., central system 102. In turn, central system 102 provide, to the request-submitting client computing system 116, a response communication indicating a list of facility items matching the criteria specified in the request, which in some cases is also augmented with relevant metadata for the returned facility items. In some implementations, the running application may pre-select, pre-populate, or pre-filter various details of the second set of UI elements 304b based upon various user-targeted criteria, such the user's account profile, which may provide details such as job responsibilities, security clearance, information access privileges, etc. In this way, computing system 100 may provide inherent security at the user input-intake stage, by limiting users to access only certain data based upon their role and clearance in an organization, while also reducing the amount of user input processing required to also determine access privileges on a per-invocation basis of the application.

Display region 308 provides a table listing each facility item identified by central system 102 or one of client computing systems 116a-n in response to the search/filtering query received at the respective client computing system 116 via user input. Each row of the table shown in display region 308 lists a different facility item. Central system 102 and/or client computing systems 116a-n enable scrolling through the list to select individual rows or a group of multiple rows in response to one or more types of user input.

The columns of the table shown in display region 308 correspond to respective attributes of the facility items. Examples of these attributes can include a unique identifier of the facility represented by the facility item, a unique identifier of the supply chain item (e.g., product or material) represented by the facility item, metrics related to the facility's processing of the facility item (e.g., inventory levels, trends, safety stock quantities, OTIF), etc. In some implementations, central system 102 and/or client computing systems 116a-n configure and potentially reconfigure the set of attributes displayed in the table of display region 308 in response to receiving one or more types of user input. For example, a respective client computing system 116 may ingest a user input indicating a selection of only a subset of available attributes that are pertinent to the presently ongoing analysis for display.

Display region 306 can include summary information of key metrics for the set of searched/filtered facility items. For example, the display region 306 can show one or more of aggregated inventory levels, trend information, average OTIF, or aggregated values of other metrics for the facility items returned in response to the user's search/filter. In some implementations, central system 102 and/or client computing systems 116a-n can effectuate the selection of a facility item (202) in response to a user input that identifies an individual row in the table of display region 308. In some implementations, responsive to receiving a user input indicating the selection of the facility item (202), the respective client computing system 116 updates the UI by replacing the current view (e.g., view 300a of FIG. 3A) with a new view (e.g., view 300b of FIG. 3B) that shows detailed information about the selected facility item (204). Again, while described above as being performed locally at the respective client computing system 116 as a non-limiting example, it will be appreciated that, in some examples, the UI updating techniques of this disclosure may be provided by central system 102 or other device with server-level capabilities.

The detailed view 300b of the UI as shown in FIG. 3B can include a range of information about the selected facility item, and in this particular example, includes a greater amount of information and/or more granular/detailed information about the selected facility item than what is displayed in a summary view of the facility item or within the table shown in display region 306 of view 300a of FIG. 3A. In the example depicted in FIG. 3B, the detailed view of the selected facility item is a “trends view” that shows historical and projected trends in the values of one or more metrics for the selected facility item. The trends are represented in view 300b by a trends plot 316. The trends plot 316 can include bar graphs, line charts, and/or other plotted representations of the metrics for the selected facility item over an interval of time. In some implementations, view 300b of the UI also includes user-selectable controls that enable central system 102 and/or the respective client computing system 116 to adjust the time interval of trends plot 316 in response to user input received at or in the general display area of the user-selectable controls.

Aspects of computing system 100 may configure the trends view shown by way of the detailed view 300b to maintain display of the header region 302 from view 300a, thereby providing a degree of continuity between these two views 300a, 300b. Detailed view 300b further includes an overview display region 310 and a details display region 312. Overview display region 310 presents a summary of key information about the selected facility item. This information can include, for example, one or more of a material ID (e.g., a unique identifier of the particular facility represented by the facility item), a facility ID (e.g., a unique identifier of the particular facility that processes the selected item), indications of the business group and/or profit center assigned to the selected facility item, values of one or more supply chain metrics for the facility item (e.g., inventory levels, trends, OTIF, product availability), etc.

In the trends view shown in FIG. 3B, the details display region 312 shows trends plot 316 that indicates trends for the selected facility item over the specified time interval. Additionally, region 312 includes a set of UI elements 314a-g in the form of tabs/buttons that can be selected by a user to immediately transition to different views of the UI that show either different modes of information for the currently selected (focused) facility item or that pertain to a related (but different) facility item.

In response to a selection of trends tab 314a, the application may prompt the respective client computing system 116 to render a trends view (e.g., detailed view 300b) for the facility item that was selected via user input or that otherwise is currently in focus. In response to a selection of BP charts tab 314b, the application may prompt the respective client computing system 116 to render a line graph of a selected metric according to business-defined control limits. In response to a selection of product flow tab 314c, the application may prompt the respective client computing system 116 to render a product flow view of the UI such as or similar to the views 300c and 300d shown in FIG. 3C and 3D for the facility item that was selected via user input or that is otherwise currently in focus. Additional detail concerning product flow views is described further below.

In response to a selection of upstream tab 314d, the application may prompt the respective client computing system 116 to render a detailed view (e.g., a trends view such as the one shown in FIG. 3B) of the UI for an upstream facility item. As used herein, an “upstream facility item” refers to a facility item that is located or processed at a previously traversed (“upstream”) facility with respect to the facility item that was selected via user input or is otherwise in focus currently. In response to a selection of downstream tab 314e, the application prompts the respective client computing system 116 to render a detailed view (e.g., a trends view such as the one shown in FIG. 3B) of the UI for a downstream facility item. As used herein, a “downstream facility item” refers to a facility item that is located or processed at a subsequently traversed (or “downstream”) facility with respect to the facility item that was selected via user input or that is otherwise in focus currently.

As such, computing system 100 utilizes interactive controls such as the upstream and downstream tabs 314e and 314d to quickly transition to views of the UI pertaining to a related (in these examples, upstream or downstream, respectively) facility item without expending the computing resources or bandwidth to process and transmit data from a manually entered user input to identify the related item and without expending the computing resources or bandwidth to process and transmit data from a series of click-through inputs to traverse several screens as in the case of accessing the related item de novo each time.

If central system 102 or other component of computing system 100 determines that more than one related (upstream or downstream, as the case may be) items exist in response to a particular user input, these aspects of computing system 100 may cause the respective client computing system 116 to output a prompt. In various examples, the prompt ay be a visual GUI element, an audio notification, a haptic output, or any other output that is intelligible to users.

If computing system 100 does not detect a user input to select one of the options in response to the prompt, computing system 100 may, as a default action, automatically select one of the items based on criteria such as geographic proximity to the facility represented by the currently focused facility item or the amount of inventory supplied to or from the related facility for the product or material represented by the currently focused facility item. Additional detail regarding upstream and downstream relationships is described with respect to FIGS. 3C and 3D.

In response to detecting a selection of focus upstream button 314f, computing system 100 may update the UI to shift focus to the next facility item upstream of the currently focused facility item. In some use case scenarios, the next facility item upstream of the currently focused facility item can be the same supply chain item (e.g., product, material, service, etc.) as that represented by the currently focused facility item, except that the upstream facility item pertains to an upstream facility's processing of that same supply chain item. In some examples, the upstream facility may represent a supplier of the currently focused facility item. If central system 102 or other component of computing system 100 detects more than one upstream facility in response to a single request, central system 102 may cause the respective client computing system 116 to output a prompt.

For example, the prompt may include a request or instruction to the user to select one of the facilities. In some examples, if computing system 100 or the pertinent component(s) thereof determine that the respective client computing system 116 has not received a user input in response to the prompt within a given time period, or under configurations in which computing system 100 bypasses the prompt-based functionalities described above, computing system 100 may, as a default option, automatically select one of the facilities based on criteria such as geographic proximity to the currently focused facility or the amount of the supply chain item supplied by each of the candidate upstream facilities to the currently focused facility, and/or other criteria.

Based on focus being applied to a facility item (whether in response to user input or by any other route consistent with this disclosure), computing system 100 and/or pertinent component(s) thereof may perform certain operations with respect to the currently in-focus facility item rather than other facility items. For example, in response to detecting user input activating/selecting trends tab 314a and product flow tab 314c, computing system 100 may cause the respective client computing system 116 to toggle between trends and product flow views of the currently in-focus facility item. In response to detecting a user input activating/selecting focus upstream button 314f from the trends view of the currently focused facility item, computing system 100 may cause the respective client computing system 116 to either update the trends view to show trends for the upstream facility item, or to render a product flow view for the upstream facility item. In response to detecting a user input indicating a selection/activation of focus upstream button 314f from the product flow view of the currently in-focus facility item, computing system 100 may update the UI output via the respective client computing system 116 to visually designate the newly focused upstream facility as the currently in-focus facility item on the flow map without exiting the product flow view.

If central system 102 or other component(s) of computing system 100 detect a user input at one of client computing systems 116a-n indicating a selection of focus downstream button 314g, computing system 100 may cause the respective client computing system 116 to shift focus to the next facility item positioned downstream of the currently in-focus facility item. In some non-limiting example use cases, the next facility item downstream of the currently focused facility item can be the same supply chain item (e.g., product, material, service, etc.) as that represented by the currently focused facility item, except that the downstream facility item pertains to a downstream facility's processing of that same supply chain item. The downstream facility may be supplied by the facility corresponding to the currently in-focus facility item. If computing system 100 determines that more than one downstream facility fit the selection input received via the respective client computing system 116, aspects of computing system 100 may case the respective client computing system 116 to output a prompt, such as an audio prompt, or a visual prompt displayed as part of or as an overlay to the UI.

The prompt may include data requesting the user to select one of the facilities. In some examples, if computing system 100 or the pertinent component(s) thereof determine that the respective client computing system 116 has not received a user input in response to the prompt within a given time period, or under configurations in which computing system 100 bypasses the prompt-based functionalities described above, computing system 100 may, as a default option, automatically select one of the facilities based on criteria such as geographic proximity to the currently in-focus facility item or the amount of the supply chain item supplied to each of the candidate downstream facilities from the currently focused facility, and/or other criteria. Responsive to detecting a user input that activates or selects the focus downstream button 314g from the trends view of the currently in-focus facility item, aspects of computing system 100 may cause the respective client computing system 116 to either update the trends view to show trends for the downstream facility item, or to render a product flow view for the downstream facility item. If aspects of computing system 100 detect a user input indicating an activation/selection of the focus downstream tab 314g from the product flow view of the currently in-focus facility item, these aspects of computing system 100 may case the respective client computing system 116 to visually designate the newly focused downstream facility as being in-focus on the flow map without exiting the product flow view of the UI.

With reference to the process 200 of FIG. 2, after rendering the detailed view (e.g., the trends view shown in FIG. 3B) of the UI for the selected facility item, the respective client computing system 116 may receive an indication (e.g. via user input or via indirect communication means) that the user has selected a flow-map control (e.g., product flow button 314c) (208). In response to detecting this selection of the flow-map control, one or more flow paths for the facility item are determined (208) and a product flow view for the selected facility item is rendered for display to the end user (210). Determination of the flow path can be performed by the respective client computing system 116, a server (e.g., central system 102), or determined in part by both.

A product (item) flow path is a description of the flow of a particular item in a supply chain between two or more facilities. The flow path of a selected facility item (or facility item that otherwise has focus) describes downstream flow, upstream flow, or both of the product represented by the selected facility item in relation to the facility represented by the selected facility item. In one non-limiting example, an item may be manufactured at a plant in Mankato, Minn., supplied to a distribution center in Louisville, Kentucky, and then shipped to a retailer in Cincinnati, Ohio. In this particular example, the flow path for the item originates in Mankato, and flows to Cincinnati via Louisville. If focus were applied to the Louisville facility, then an upstream segment of the flow path would be represented by a directed link from the Mankato to the Louisville facility, and a downstream segment of the flow path would be represented by a directed link from the Louisville to the Cincinnati facility. In some other non-limiting examples, more than one downstream and/or upstream segments may exist. Moreover, a given facility item may have multiple upstream suppliers and/or may supply multiple downstream facilities. In such cases, product flow paths may extend through each branch.

FIGS. 3C and 3D depict screenshots of product flow views 300c and 300d for a selected facility item. These figures illustrate the rendering of an example flow path on a map consistent with operation 210 from FIG. 2. Product flow view 300c of FIG. 3C maintains header display region 302 and overview display region 310 from the trends view shown in FIG. 3B. However, the content of region 312 has changed from providing a trends plot 316 to providing a product flow map 318 for the facility item that was initially selected by the user (or that otherwise has current focus). In this example, a facility in Chicago, Ill. has current focus because the selected facility item relates to that facility's processing of ‘Widget XY.’

The flow map 318 includes an upstream segment that indicates that the Chicago facility is supplied ‘Widget XY’ from an upstream facility in Europe. Flow map 318 further includes a first-order downstream segment indicating that the Chicago facility supplies ‘Widget XY’ to a downstream facility in Columbia, Missouri, and a second-order downstream segment indicating that the Columbia facility supplies ‘Widget XY’ to a downstream facility in Minneapolis, Minnesota. Each of these facilities in the flow path is represented on the map by visual markers 320a-d overlaid at locations on the map that correspond to their geographic locations in the real world. Arrows showing the direction of flow of the item connect the facilities on flow map 318.

In some implementations, aspects of computing system 100 may visually emphasize the facility item that is currently in focus relative to other facilities that do not have focus in the UI output by the respective client computing system 116. For example, visual marker 320b for the Chicago facility maybe represented in a different color or distinguished in another visual way from the other markers 320a, 320c, and 320d in FIG. 3C. This visual emphasis can change to a different marker if aspects of computing system 100 receive and process a user input indicating a selection to apply focus to a downstream or upstream facility. The visual markers 320a-d can take a variety of forms such as pins, icons, graphics, text, or a combination of these. In some implementations, aspects of computing system 100 may configure visual markers 320a-d to be interactive UI elements, the use of which enables human-machine interaction between the user and aspects of computing system 100.

If aspects of computing system 100 detect a user input corresponding to a “hover” gesture in which a pointer hovers over a visual marker 320, and/or a “click” gesture corresponding to a click input entered while the pointer is at least partially overlaid on a visual marker 320 for a particular facility on the flow map 318 to select the indicated visual marker 320, computing system 100 may cause the respective client computing system 116 to apply focus to the facility (and facility item) represented by the selected visual marker 320, display a pop-up window at or near the selected visual marker 320 showing one or more details about the selected facility or corresponding facility item represented by the selected visual marker 320, and/or render the trends view for the facility item represented by the selected visual marker 320.

In some implementations, computing system 100 causes the respective client computing system 116 to pan flow map 318 in the UI in response to various types of user input, thereby displaying user-configured views of different geographic areas within the bounds of the viewport. Computing system 100 may operate zoom control 322 as an interactive element by responding to user input entered at the in-UI location corresponding to zoom control 322 to zoom into or out of flow map 318 to a specified zoom level or specified granularity. For instance, view 300c shows a relatively zoomed-out view spanning much of North America and Europe. In contrast, view 300d shows flow map 318 at a closer zoom level that focuses on or isolates a portion of the United States where three of the facilities denoted by visual markers 320b-d are located. Both views 300c and 300d maintain buttons 314a-g within display region 312 to enable efficient transitions between display modes and quick access to and output of information regarding upstream or downstream facility items.

Referring again to FIG. 2, boxes 212-232 show four alternate action routes that aspects of computing system 100 may implement in response to receiving different selection indications provided in various instances of user input received via client computing systems 116a-n. The different selections provided in the different user inputs may all originate from a product-flow view (e.g., views 300c or 300d) rendered at one or more of client computing systems 116a-n, in certain examples. Boxes 212 & 214 illustrate a course of action, boxes 216-220 illustrate a second course of action, boxes 222 & 224 illustrate a third course of action, and boxes 226-232 illustrate a fourth course of action that computing system 100 may implement in response to different selections indicated in different instances of user input received via input hardware of client computing systems 116a-n.

Starting from the product flow view (e.g., views 300c or 300d), according to the first course of action, input hardware of the respective client computing system 116 receives a user input indicating a selection of a particular visual marker (e.g., visual marker 320b) displayed on a currently rendered flow map (e.g., flow map 318) for a facility in a depicted flow path (212). In response to the selection of the visual marker (visual marker 320b in this particular example), aspects of computing system 100 cause the respective client computing system 116 to render a detailed view (e.g., trends view 300b) for the facility item or the facility corresponding to the selected marker (214).

Starting from the product flow view (e.g., views 300c or 300d), according to the second course of action, input hardware of the respective client computing system 116 receives a user input indicating a selection of a detailed-view UI control (e.g., trends view button 314a) (216). In response, the computing system 100 identifies the facility or facility item with current focus (218), and replaces the product flow view (e.g., view 300c or 300d) with a detailed view (e.g., trends view 300b) for the facility or facility item that has current focus in the system (220).

Starting from the product flow view (e.g., views 300c or 300d), according to the third course of action, input hardware of the respective client computing system 116 receives a user input indicating an instruction (e.g., via selection/activation of tab 314f or tab 314g) to shift focus to another facility upstream or downstream of the currently in-focus facility (222). In response, aspects of computing system 100 may cause the respective client computing system 116 to update the UI such that the new view applies focus to the next upstream or downstream facility, according to the instruction indicated in the user input received at the respective client computing system 116 (224).

Starting from the product flow view (e.g., views 300c or 300d), according to the fourth course of action, input hardware of the respective client computing system 116 receives a user input indicating a selection of an upstream or downstream detailed view control (e.g., via activation/selection of one of tabs 314d or 314e) (226). In response, computing system 100 identifies the facility that is currently in focus (228), identifies a second facility having an upstream or downstream relationship to the facility that is currently in focus (230), and causes the respective client computing system 116 to render, in the UI, a detailed view (e.g., trends view 300b) for the second facility (232). In some examples, the detailed view for the second facility can specifically pertain to the same product or supply chain item as the facility item that was previously the object of focus. In other examples, the detailed view for the second facility can more broadly present information related to the second facility's processing of a range of items.

FIGS. 4A-4E are conceptual diagrams showing representations of facilities in a supply chain, in accordance with one or more aspects of this disclosure. For instance, FIGS. 4A-4E may depict screenshots of additional views of the UIs that client computing systems 116a-n display to users via display hardware. Aspects of computing system 100 operate the UI views shown in FIGS. 4A-4E to efficiently access and output (e.g., for visual display or in other ways) information about facilities in a supply chain in response to receiving various types (or potentially, sequences) of user input data. In some implementations, a same client device application that rendered the screenshots shown in FIG. 3A-3D can be further configured to generate the views shown in one or more of FIGS. 4A-4E.

One or more of client computing systems 116a-n can run the client device application to render the views shown in FIGS. 4A-4E. To start, the respective client computing system 116 may render a first view 400a of the UI, as shown in FIG. 4A. View 400a includes display regions 302, 304, 306, and 308. Region 302 can include header information like the headers provided in views 300a-300d. Region 304 includes search and filtering tools that enable targeting according to specified geographic and/or product criteria for a target set of facilities of interest. Region 306 provides an overview of facility information for the target set of facilities (e.g., facilities that meet the search and/or filtering criteria included in the user input received at the respective client computing system 116). In some implementations, if no search or filtering criteria are specified, the target set of facilities includes all registered facilities in the supply chain.

Region 306 includes a set of UI elements 408a-408f that each correspond to different supply chain metrics such as actual inventory amount in currency amounts (e.g., U.S. dollars, or any other currency), trends, target inventory level, backorders amount in terms of currency (e.g., U.S. dollars, or any other currency), product availability percentage, OTIF percentage, and parameter accuracy percentage. UI elements 408a-f can show computed aggregates of the values for their corresponding metrics across all facilities in the target set of facilities. For instance, aspects of computing system 100 may include or show the total inventory amount across the target facilities in view 400a in UI element 408a, and may include or shown the average OTIF percentage across target facilities in UI element 408e. Furthermore, UI elements 408a-f can have various types of form factors, such form factors of tabs, buttons, or other user-selectable elements that, when selected, case the client device application to output an update to the display of the facility map 402 so that visual markers for the target set of facilities indicate values of the corresponding metric for the selected element.

Computing system 100 configures view 400a such that display region 308 includes a facility map 402 and a map legend 404. Facility map 402 comprises a map of a geographic area overlaid with visual markers 406a-n that represent individual facilities or groups of proximally located facilities in a supply chain. Each facility within the target set of facilities can be represented by one or visual markers 406a-n, while facilities not within the target set are not marked on the map 402 in the example of view 400a. The visual marker 406 for an individual facility can be formatted in a manner that visually represents the value of the selected supply chain metric. For instance, as shown in FIG. 4A, the visual markers 406a-n have a circular shape centered at a location on the map corresponding to the geographic location of the represented facility.

The size of each circle corresponds to the value of the selected supply chain metric, such as the amount of inventory stored at the facility based on the inventory level being the selected supply chain metric. In some implementations, aspects of computing system 100 may adjust two or more attributes of the visual markers 406a-n to represent values of additional metrics in response to a determination that more than one metric is selected. For example, computing system 100 may configure the UI such that the circular markers of visual markers 406a-n are size-coded according to inventory amount and color-coded according to OTIF percentage. In some implementations, computing system 100 may configure visual markers 406a-n to be color-coded based on the selected supply chain metric.

For instance, computing system 100 may configure view 400a such that blue circles indicate that the selected metric is inventory amount while black circles indicate that the selected metric is OTIF percentage. Color-coding according to aspects of this disclosure may refer to outline color, fill color, highlight color, shadow color, etc. In various examples, the circles described with respect to FIG. 4A may be referred to as “bubbles” and the dots described with respect to FIG. 4A may be referred to as “markers.” In some examples, computing system 100 may size the bubbles based the corresponding value amount (e.g., smaller-diameter bubbles for lesser value and larger-diameter bubbles for greater value). In some examples, view 400a represents a “legends view” or “legend view” of the UIs of this disclosure.

Computing system 100 may implement geographic filtering aspects of this disclosure to geographically limit the set of facilities displayed on the map 402. Computing system 100 may implement product filtering aspects of this disclosure to limit the set of target facilities by restricting to only those facilities that process items that match the product criteria. In some examples, product filtering aspects of this disclosure may also impact the values of the metrics conveyed to the user for each facility. In some examples, rather than aggregating the values of all items processed by the facilities, the client device application running on client computing systems 116a-n may aggregate the values of only those items matching the product filtering criteria. Computing system 100 may cause one or more of client computing systems 116a-n to then display the aggregated values on the filtered set by way of UI elements 408a-f and represented by visual markers 406a-n.

In some use case scenarios, multiple facilities are located in close geographic proximity of each other. Several warehouses, for example, may be constructed adjacent to each other on a large piece of real estate. Rendering separate visual markers on a facility map for each proximately located facility may be impractical because it may be difficult for users to perceive or distinguish between the visual markers (especially where the map view is zoomed out to encompass a much larger area). Additionally, the provision of individual markers for each facility may clutter the display on the map, diminishing the user experience and diminishing data precision in terms of the data being output via the UI.

To address these and other technical problems, the client device application of this disclosure may be configured to identify groups of proximally located facilities, and to render over the facility map, just a single visual marker for the group as a whole rather than individual markers for each facility in the group. In some implementations, computing system 100 may set attribute(s) such as size and color of the visual marker for a group of facilities based on aggregated or averaged values of the selected metric(s) for the facilities in the group. For example, computing system 100 may aggregate inventory levels across the facilities in a group, and may use the aggregated inventory level to size the circular marker representing the group of facilities, in accordance with the size-coding aspects of this disclosure. Aspects of computing system 100 may determine groups of proximally located facilities based on factors such as one or more of the distance between the facilities, the current zoom level of the facility map, the size or resolution of the facility map as rendered on the display of the respective client computing system 116, and/or the number of visual markers presented within all or a portion of the facility map. In some implementations, the techniques for formatting visual markers of facilities as shown in FIG. 4A-4E can be applied in a corresponding manner to the formatting of visual markers overlaid on the item flow maps depicted in FIG. 3A-3D.

FIG. 4B depicts a second view 400b of the UI. Like view 400a, view 400b depicts a facility map 402. However, in view 400b, UI element 408b has been selected, and the visual markers have been re-rendered on the map 402 to be sized according to the target inventory levels of the facilities (i.e., the metric associated with element 408b) rather than sized according to actual inventory levels (i.e., the metric associated with element 408a).

FIG. 4C depicts a third view 400c of the UI. In the use case scenario illustrated in FIG. 4C, a received user input specified a product filter by restricting results to those related to products within a selected profit center. The target facilities are thus limited to facilities that process items within the selected profit center, and only these facilities are shown on the facility map 402.

FIG. 4D depicts a fourth view 400d of the UI. Like view 400c, view 400d is filtered based on a selected profit center. The view is also zoomed into a view of the United States, e.g., based on user input provided at zoom control 322. As shown, if user input causes the pointer to hover over or a click input indicates a selection of a visual marker, computing system 100 invokes a pop-up window 422 near the selected visual marker, with the pop-up window 422 displaying values of certain metrics for the facility. A description and identifier of the facility represented by the visual marker can also be presented in the pop-up window 422. When the visual marker represents a group of facilities, computing system 100 may identify and list each facility in the group in the pop-up window 422.

FIG. 4E depicts a fifth view 400e of the UI. The client application of this disclosure may be configured to render the fifth view 400e in response to receiving user input data indicating a selection of a visual marker for a particular facility on the facility map 402 and/or in response to receiving user input data indicating a selection of an element within pop-up window 422. The fifth view 400e includes header display region 302, an overview display region 424, and an items display region 426. The overview display region 424 is configured to present values of metrics and other details about the selected facility (e.g., the Rockford, Illinois facility shown in FIG. 4E). The items display region 426 presents a table listing items processed by the selected facility (and associated metrics and metadata for the listed items).

FIGS. 3A-4E, and the transitions between the views shown in these respective drawings, illustrate various technical improvements provided by the systems of this disclosure. By causing client computing systems 116a-n to transition between the various views illustrated in FIGS. 3A-4E in response to receipt of various types of user input data, computing system 100 outputs dynamically updated views on inventory to suit user needs, while maintaining a consistent dashboard that enables input of a variety of user inputs to update the view. Examples of inventory attributes that computing system 100 supports are inventory location, inventory status (e.g., available, backorder, OTIF, etc.), and others. By maintaining a static dashboard through all of the illustrated views and the transitions therebetween, computing system 100 implements the techniques of this disclosure to reduce the computing resource and bandwidth consumption required to transition between views showing different permutations and combinations of various inventory attribute subsets, while fulfilling user requests without undue time lags.

As shown by way of the transitions between the various views illustrated in FIGS. 3A-4E, computing system 100 enables user input-triggered bottom-up rollup functionalities substantially in real time. Additionally, computing system 100 enables user input-driven grouping of multiple key performance indicators (KPIs) together in a view, as opposed to singular views and/or singular systems that require additional iterations of user input-driven transitions to output various KPIs. Several of the views shown in FIGS. 3A-4E, as well as other views that computing system 100 may output via client computing systems 116a-n in accordance with aspects of this disclosure represent unified views of data that is grouped using standard definitions. By implementing the data grouping techniques of this disclosure, computing system 100 enables users of client computing systems 116a-n to use the displayed UIs to visualize inventory-related data trends based on one or more of various types and scalable granularities of criteria. In some non-limiting examples of forming inventory-related data trends using temporal criteria, computing system 100 may output inventory-related trend data by day, going back 24 months, and the like.

In other use case scenarios, computing system 100 may, based on user input data received via client computing systems 116a-n, configure the UIs of FIGS. 3A-4E or other UIs consistent with this disclosure to include one or more of cause and effect information with respect to parameter setup, forecast information, supply information, demand forecast vs actual demand, resulting inventory and/or service, etc. The product position maps and product flow maps, which are optionally augmented with commentary and/or comment linkage to trend information, as shown in FIGS. 3A-4E. Computing system 100 also provides scalability with respect to increasingly rich and voluminous data associated with complex supply chains, and provides backward compatibility of data, such as by merging legacy inventory information for facility items together with facility items managed by currently in-use enterprise resource planning (ERP) tools.

By way of the UIs of this disclosure (such as, but not limited to, the UI views shown in FIGS. 3A-4E), computing system 100 may provide various functionalities such as bookmarking to enable users to reinvoke previously viewed and pinpointed data, exception focus capabilities, opportunity information, etc. These functionalities are provided in a way that is repeatable and fast, while accommodating the ability to show change (e.g. trends over time) whether with respect to historical data or to forecast data. In this way, computing system 100 enables single-click or other simple input-based drill-down or directed intuitive drill-down views of data filtered using certain custom criteria, while also enabling single-click or other simple input-based reversions to coarser-grained information to exit the drill-down views.

In one or more of the views shown in FIGS. 3A-4E, computing system 100 may configure the corresponding UI(s) to include an action tab, such as on a detail screen. Computing system 100 may process user inputs received at areas corresponding to the action tab to receive comments and/or action instructions entered by users regarding on exceptions. Computing system 100 may retain data representing the entered comments and/or action instructions (e.g., as a note that persists) to provide a historical log of actions. In some examples, and potentially in response to receiving an input requesting the historical log, computing system 100 may output the persisting data via one of client computing systems 116a-n. Various formats that computing system 100 may use for outputting the historical log data include tabular format, a visual (e.g., diamond flag format) or others when overlaying the log on the item or facility chart.

Computing system 100 may also implement aspects of this disclosure to provide bookmarking capabilities that save filter settings, sort settings, and/or view settings (e.g., as formulated via user inputs) for organization and quick retrieval at later times or a next use. In this way, computing system 100 may provide custom or near-custom views and access to numerous businesses rather than requiring a renewed setup at each instance of application access.

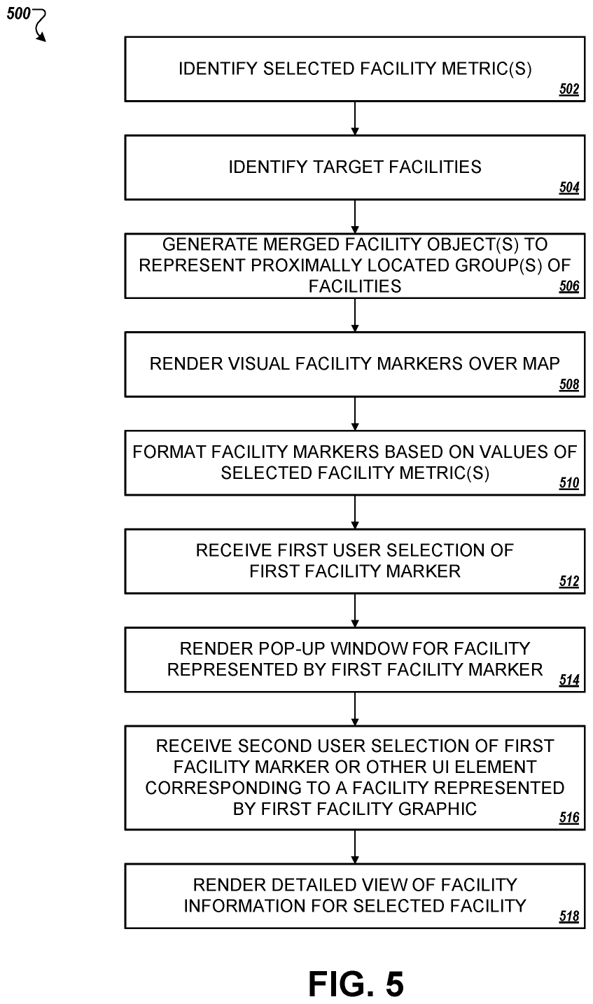

FIG. 5 is a flowchart illustrating an example process 500 for rendering facility maps in a user interface. Process 500 can be performed by the front-end of a supply chain management system, e.g., computing system 100 of FIG. 1. In some implementations, process 500 is performed by a client device of an end user, e.g., any of client computing systems 116a-n of FIG. 1. The client device identifies one or more facility metrics selected by a user (502). The client device also determines a set of target facilities, e.g., based on comparison of search or filtering criteria received as part of user input data with geographic and/or product attributes of facilities registered with the system (504). In some cases, the client device determines one or more groups of proximally located facilities and creates merged (composite) facility object to represent the groups (506).

The client device renders visual markers for the non-proximally located facilities and the merged facilities over a map of a geographic area (i.e., a facility map) (508). The client device can format visual attributes of the markers according to the values of the selected metric(s) associated with the facilities (510). The client device receives a user input indicating a selection, from the facility map, of the visual marker for a particular facility of interest (512). In response, the client device may render a pop-up window (e.g., pop-up window 422) in the vicinity of the visual marker, with the pop-up window showing additional information about the facility (514). The client device may receive user input data indicating a selection the visual marker for the facility a second time or in a different fashion, or may select another UI element presented alongside the facility map (516). In response, the client device renders a detailed view (e.g., fifth view 400e) of information about the selected facility (518).

Embodiments of the subject matter described in this specification can be implemented in a computing system that includes a back-end component, e.g., a data server, a middleware component, e.g., an application server, and/or a front-end component, e.g., a client computer or client device. The components of the system can be interconnected by any form or medium of digital data communication, e.g., a communication network. Examples of communication networks include a local area network (LAN) and a wide area network (WAN), e.g., the Internet.

The computing system can include client computing systems and servers. A client device and server are typically located a substantial distance from each other, but are configured to interact through a communication network. The relationship of a client devices and server can arise by virtue of computer programs running on the respective computers and having a client-server relationship to each other. In some implementations, a server transmits data, e.g., an HTML, page, to a user device, e.g., for purposes of displaying data to and receiving user input from a user interacting with the user device, which acts as a client device. Data generated at the user device (client device), e.g., a result of the user interaction, can be received from the user device at the server.

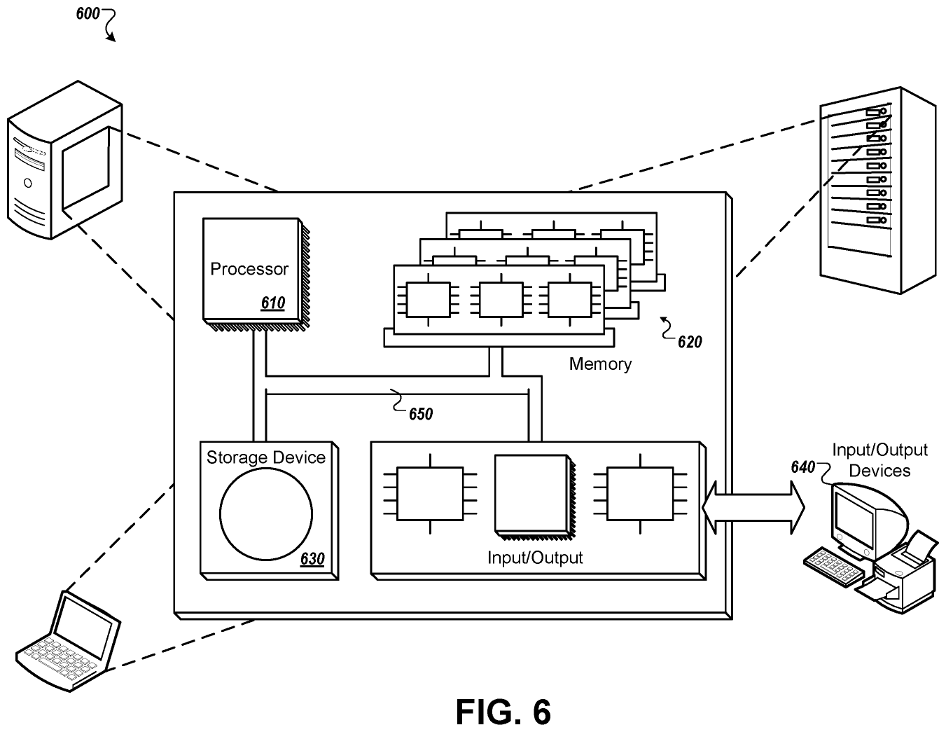

An example of one such type of computer is shown in FIG. 6, which depicts a schematic diagram of a generic computer system 600. The system can be used for the operations described in association with any of the computer-implemented methods described in this specification. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In various implementations, the processor 610 represents one or more of a single-threaded processor, a multi-threaded processor, a multi-core processor, a controller, a digital signal processor (DSP), an application specific integrated circuit (ASIC), a field-programmable gate array (FPGA), processing circuitry (e.g., fixed function circuitry or programmable circuitry or any combination thereof) or equivalent discrete or integrated logic circuitry. The processor 610 is operable or configured to process instructions stored in the memory 620 or on the storage device 630 to display graphical information for a user interface on the input/output device 640.

The memory 620 stores information within the system 600. In various implementations, the memory 620 represents one or more of a computer-readable medium (e.g., a non-transitory computer-readable storage medium), a volatile memory unit, a non-volatile memory unit, random-access memory (RAM), read only memory (ROM), programmable read only memory (PROM), erasable programmable read only memory (EPROM), electronically erasable programmable read only memory (EEPROM), flash memory, or any form of memory operable to store data and/or executable instructions.

The storage device 630 is capable of providing mass storage for the system 600. In one implementation, the storage device 630 is a computer-readable medium. In various implementations, the storage device 630 may be a solid state drive (SSD), a flash drive floppy disk device, a hard disk device, an optical disk device, a tape device, magnetic media, optical media, or other computer-readable media or computer-readable storage device(s).

The input/output device 640 provides input/output operations for the system 600. In one implementation, the input/output device 640 includes one or more of a keyboard, mouse, stylus, presence-sensitive screen (e.g., a touchscreen), a pointing device, etc. In another implementation, the input/output device 640 includes a display unit for displaying graphical user interfaces.

While this specification sets forth many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims.

What is claimed is:

1. A computer-implemented method comprising:
receiving, by a computing system, an indication of a selected facility item, wherein the selected facility item represents a particular supply chain item that is processed at a particular facility of a plurality of facilities in an organization;
rendering, by the computing system for display on a screen of the computing system, a first view of a user interface pertaining to the selected facility item, wherein the first view of the user interface includes an item flow map that shows a flow of the particular supply chain item represented by the selected facility item between at least two facilities of the plurality of facilities, the at least two facilities including the particular facility represented by the selected facility item;
receiving, by the computing system, a selection of a first user interface element shown within the first view of the user interface; and
in response to receiving the selection of the first user interface element shown within the first view of the user interface, rendering, by the computing system for display on the screen, a second view of the user interface that shows additional information pertaining to the selected facility item or the particular facility represented by the selected facility item, wherein the additional information is not shown in the first view of the user interface.

2. The computer-implemented method of claim 1, wherein receiving the indication of the selected facility item comprises receiving an indication of (i) an item identifier that uniquely represents the particular supply chain item, and (ii) a facility identifier that uniquely represents the particular facility.

3. The computer-implemented method of claim 1, wherein the first user interface element is a tab that is included both in the first view of the user interface and in the second view of the user interface.

4. The computer-implemented method of claim 1, wherein the second view of the user interface does not include the item flow map, and wherein the second view of the user interface includes at least one other user interface element that shows the additional information pertaining to the selected facility item or the particular facility represented by the selected facility item.

5. The computer-implemented method of claim 1, wherein the additional information pertaining to the selected facility item comprises values of one or more metrics related to processing of the particular supply chain item at the particular facility.

6. The computer-implemented method of claim 5, wherein the one or more metrics related to the processing of the particular supply chain item at the particular facility comprise one or more of a monetary value of an inventory of the particular supply chain item at the particular facility, a quantity of the particular supply chain item at the particular facility, a target level of the inventory of the particular supply chain item at the particular facility, a level of backorders of the particular supply chain item at the particular facility, or a percentage of on-time and in-full (OTIF) deliveries of the particular supply chain item made from the particular facility.

7. The computer-implemented method of claim 1, wherein the second view of the user interface includes a plot showing values of one or more metrics related to the processing of the particular supply chain item at the particular facility over a predetermined interval of time.

8. The computer-implemented method of claim 7, wherein the predetermined interval of time is adjustable based on user input received via input hardware of the computing system.

9. The computer-implemented method of claim 1, further comprising:
receiving, by the computing system, while the second view of the user interface is rendered for display, user input data indicating a selection of the first user interface element or a second user interface element; and
in response to receiving the user input data indicating the selection of the first user interface element or the second user interface element, rendering, by the computing system for display on the screen, the first view of the user interface that includes the item flow map.

10. The computer-implemented method of claim 1, further comprising:
receiving, via input hardware of the computing device, while the first view of the user interface is rendered for display or while the second view of the user interface is rendered for display, user input data indicating a selection of a second user interface element; and
in response to receiving the user input data indicating the selection, rendering, by the computing device for display on the screen, a third view of the user interface pertaining to a processing of the particular supply chain item represented by the selected facility item at a second facility that represents one of (i) an upstream facility that supplies the particular supply chain item to the particular facility, or (ii) a downstream facility that receives a supply of the particular supply chain item from the particular facility.

11. The computer-implemented method of claim 1, further comprising:
collecting data identifying the particular facility represented by the selected facility item;
identifying a second facility upstream of the particular facility that supplies the particular supply chain item to the particular facility; and
identifying one or more third facilities other than the particular facility that are located downstream of the second facility such that the second facility supplies the one or more third facilities with the particular supply chain item,
wherein rendering the first view of the user interface comprises including rendering visual markers on the item flow map corresponding to the particular facility, the second facility, and the one or more third facilities.

12. The computer-implemented method of claim 1, wherein the particular facility represented by the selected facility item is shown as being in focus in the first view of the user interface, the method further comprising:
receiving, while the particular facility is shown as being in focus, a first user input indicating a selection of a second user interface element;
in response to receiving the first user input indicating the selection of the second user interface element:
showing the particular facility as not being in focus; and
showing a second facility as being in focus, wherein the second facility is either an upstream facility or a downstream facility of the particular facility with respect to the particular supply chain item;
receiving, by the computing system, a second user input indicating a selection of the first user interface element or a third user interface element while the second facility is shown as being in focus; and
in response to receiving the second user input indicating the selection of the first user interface element or the third user interface element, rendering, for display by the screen, a view of the user interface that pertains to the second facility.

13. The computer-implemented method of claim 12, wherein the view of the user interface that pertains to the second facility is a view that pertains to a processing of the particular supply chain item at the second facility.

14. The computer-implemented method of claim 12, wherein at least one of the first view of the user interface or the second view of the user interface represents a view of the user interface that pertains to the selected facility item.

15. The computer-implemented method of claim 12, wherein the second user interface element is a visual marker representing the second facility, and wherein the second user interface element is displayed on the item flow map.

16. The computer-implemented method of claim 12, wherein the second user interface element represents a selectable control.

17. The computer-implemented method of claim 12, wherein rendering the user interface comprises rendering the user interface via a web browser application executing on the computing system.

18. The computer-implemented method of claim 1, wherein the item flow map includes a background map of a geographic region and a plurality of visual markers overlaid on the background map, the plurality of visual markers including a first visual marker corresponding to the particular facility represented by the selected facility item, one or more second visual markers corresponding to one or more other facilities in the organization that are different from the particular facility and process the particular supply chain item represented by the selected facility item, and one or more third visual markers depicting a flow of the selected facility item between the at least two facilities.

19. A computing system comprising:
a memory;
display hardware; and
one or more processors in communication with the memory and the display hardware, the one or more processors being configured to:
receive an indication of a selected facility item, wherein the selected facility item represents a particular supply chain item that is processed at a particular facility of a plurality of facilities in an organization;
render, for display via the display hardware, a first view of a user interface pertaining to the selected facility item, wherein the first view of the user interface includes an item flow map that shows a flow of the particular supply chain item represented by the selected facility item between at least two facilities of the plurality of facilities, the at least two facilities including the particular facility represented by the selected facility item;
receive a selection of a user interface element shown within the first view of the user interface; and
in response to receipt of the selection of the user interface element shown within the first view of the user interface, rendering, by the computing system for display on the screen, a second view of the user interface that shows additional information pertaining to the selected facility item or the particular facility represented by the selected facility item, wherein the additional information is not shown in the first view of the user interface.

20. A non-transitory computer-readable medium encoded with that, when executed by one or more processors, cause the one or more processors to:
receive an indication of a selected facility item, wherein the selected facility item represents a particular supply chain item that is processed at a particular facility of a plurality of facilities in an organization;
render, for display via display hardware coupled to the one or more processors, a first view of a user interface pertaining to the selected facility item, wherein the first view of the user interface includes an item flow map that shows a flow of the particular supply chain item represented by the selected facility item between at least two facilities of the plurality of facilities, the at least two facilities including the particular facility represented by the selected facility item;
receive a selection of a user interface element shown within the first view of the user interface; and
in response to receipt of the selection of the user interface element shown within the first view of the user interface, rendering, by the computing system for display on the screen, a second view of the user interface that shows additional information pertaining to the selected facility item or the particular facility represented by the selected facility item, wherein the additional information is not shown in the first view of the user interface.
